(19) United States
(12) Patent Application Publication
(10) Pub. No.: US 2005/0218273 A1
(43) Pub. Date: Oct. 6, 2005

(54) Universal adaptor used in display

(76) Inventor: Min-Hua Huang, Kaohsiung (TW)

Correspondence Address: Min-Hua Huang, 235 Chung - Ho, Box 8-24, Taipei, TW

(21) Appl. No.: 10/813,238

(22) Filed: Mar. 31, 2004

(51) Int. Cl. B68G 5/00; A47G 29/00

(52) U.S. Cl. 248/126

(57) ABSTRACT

A universal adaptor used in a display comprises a retaining seat formed by punching a metal plate; the retaining seat being fixed to a wall by a stud; an adapting seat having an inward protruded dome-like surface; a rotary seat locked to a backside of a liquid crystal display; the rotary seat having a forward protruded dome-like surface matched to the dome-like surface of the adapting seat; a clamping element having a dome-like shape matched to the dome-like surface of the adapting seat; a plurality of elastic pad; each elastic pad having a round pad; a center of each elastic pad having a round hole; a plurality of elastic pads being linearly arranged so as to combined as a strong elastic element; and a stud having a rectangular end portion.

### FIELD OF THE INVENTION

The present invention relates to adaptors, and particular to a universal adaptor used in a display, wherein a liquid crystal display with the adaptor of the present invention can be suspended to a wall or an object. Thereby, the liquid crystal display can be used widely. Thereby, the orientation adjustment of the liquid crystal display is wide.

### BACKGSEMI-ROUND OF THE INVENTION

With reference to FIG. 1, the orientation adjustment of a liquid crystal display is illustrated. The liquid crystal display 10 has a back plate 11 at the backside thereof. A backside of the back plate 11 has two ears 12. Each ear is transversally installed to a supporting frame 14 of the liquid crystal display 10 by a shaft 13. Thereby, the liquid crystal display 10 is rotatable around the shaft 13 so as to adjust the orientation.

However, in above mentioned structure, the shaft 13 between the ears 12 and the supporting frame 14 is used as a fulcrum. Only elevation angle is adjustable, see FIG. 2. Obviously, the liquid crystal display 10 can not be adjusted to a desired orientation. If the liquid crystal display 10 is placed on a table, maybe this function is sufficient, but if the liquid crystal display 10 is arranged to other place, such as being suspended from a wall or other object, then the prior art design cannot match the requirement.

### SUMMARY OF THE INVENTION

Accordingly, the primary object of the present invention is to provide a universal adaptor used in a display. The universal adaptor comprises a retaining seat formed by punching a metal plate; the retaining seat being fixed to a wall by a stud; an adapting seat having an inward protruded dome-like surface; a rotary seat locked to a backside of a liquid crystal display; the rotary seat having a forward protruded dome-like surface matched to the dome-like surface of the adapting seat; a clamping element having a dome-like shape matched to the dome-like surface of the adapting seat; a plurality of elastic pad; each elastic pad having a round pad; a center of each elastic pad having a round hole; a plurality of elastic pads being linearly arranged so as to combined as a strong elastic element; and a stud having a rectangular end portion.

In assembly, the stud passes through the round holes of the elastic pads; a round hole in the center of the clamping element; a round hole of the adapting seat; and a rectangular hole in the center of the rotary seat; a front end of the stud protruded from the rotary seat is locked with a nut. Thereby, the adapting seat, rotary seat, clamping element and plurality of elastic pads are combined. Furthermore, by the elastic force of the elastic pads, the clamping element and the rotary seat are tightly clamped at two sides of the dome-like surface of the adapting seat. Thus, the rotary seat is supported and fixed to the liquid crystal display. The rotary seat and the clamping element fixed to the backside of the liquid crystal display are adjusted so as to adjust the elevation angle thereof, or to adjust horizontal angle, or to rotate through a whole cycle.

The various objects and advantages of the present invention will be more readily understood from the following detailed description when read in conjunction with the appended drawing.

### BRIEF DESCRIPTION OF THE DRAWINGS

FIG. 1 is a perspective view of a prior art display.

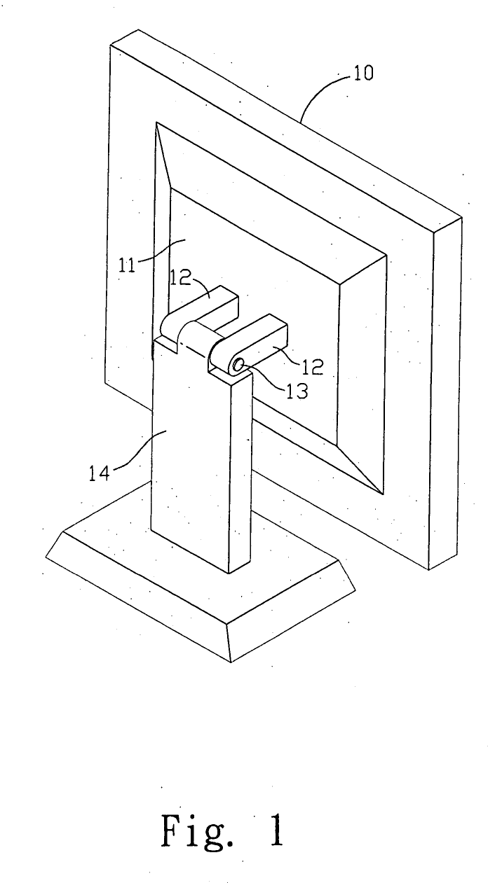

FIG. 2 is a lateral schematic view showing the operation of a prior art display.

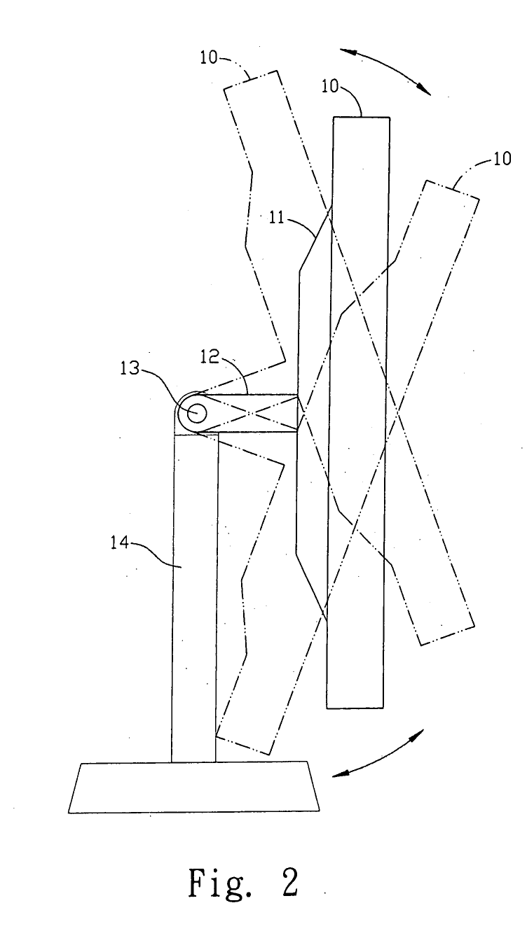

FIG. 3 is an exploded perspective view of the present invention.

FIG. 4 is a lateral cross section view about the elevation adjustment of the present invention.

FIG. 5 is a cross section view about the horizontal adjustment of the present invention.

FIG. 6 is a front view about the rotation adjustment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope-and spirit of the present invention defined in the appended claims.

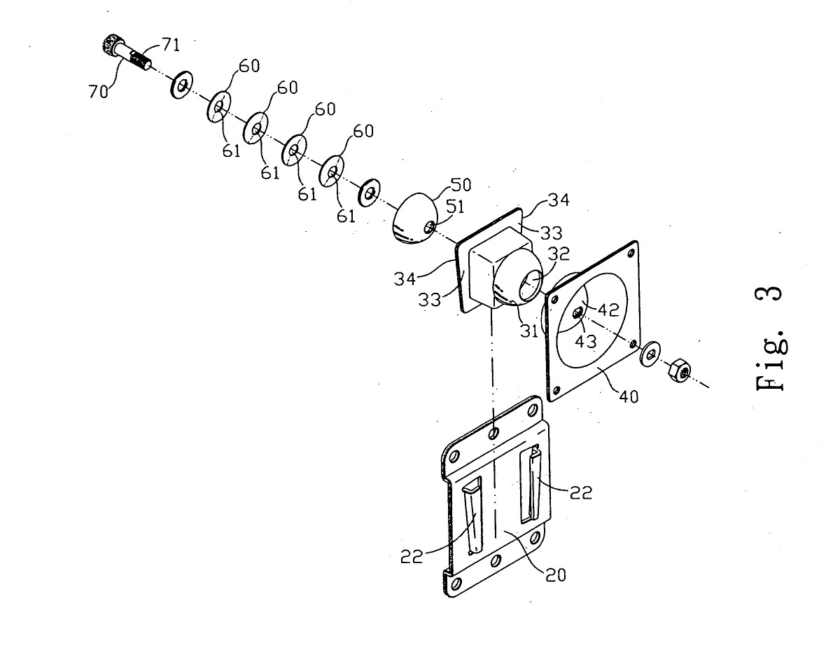

With reference to FIGS. 3 to 6, the structure of the present invention is illustrated.

The present invention includes the following elements.

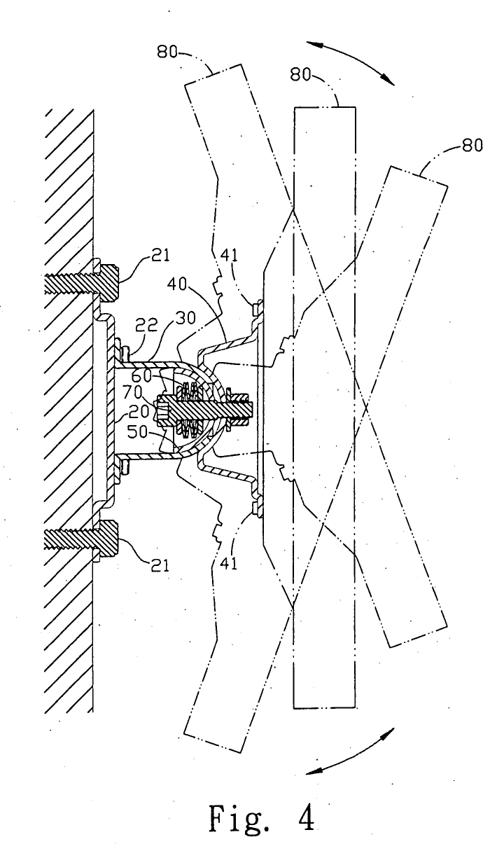

A retaining seat 20, as shown in FIG. 4, is formed by punching a metal plate. The retaining seat 20 can be fixed to a wall by a stud 2. A front surface of the retaining seat 20 has two ears 22. Each ear 22 is inclined inwards and downwards. A gap between upper ends of the two each ears 22 is larger than a gap between lower ends of the two ears 22.

An adapting seat 30, see FIG. 4, is made by punching a metal plate. The adapting seat 30 has an inward protruded dome-like surface 31. A center of the surface 31 has a round hole 32. A periphery of the adapting seat 30 is a lip 33. Two sides of the lip 33 are formed with respective inclined surfaces 34 so that the adapting seat 30 can be fixed to the retaining seat 20 by placing the inclined surfaces 34 between the two ears 22. Thereby, the adapting seat 30 is combined to the retaining seat 20.

A rotary seat 40, see FIG. 4, is made by punching a metal plate. The rotary seat 40 is locked to a backside of a liquid crystal display 80. The rotary seat 40 has a forward protruded dome-like surface 42 which can be matched to the dome-like surface 31 of the adapting seat 30. A center of the dome-like surface 42 is a rectangular hole 43.

A clamping element 50, see FIG. 4, is made by punching a metal plate. The clamping element 50 has a dome-like shape is matched to the dome-like surface 31 of the adapting seat 30. A center of the clamping element 50 has a round hole 51.

A plurality of elastic pads 60, see FIG. 4, are made by punching a metal plate. The elastic pad 60 has a round pad. A center of the elastic pad 60 has a round hole 61. A plurality of elastic pads 60 are linearly arranged so as to combined as a strong elastic element.

A stud 70, see FIG. 4, has a rectangular end portion 71.

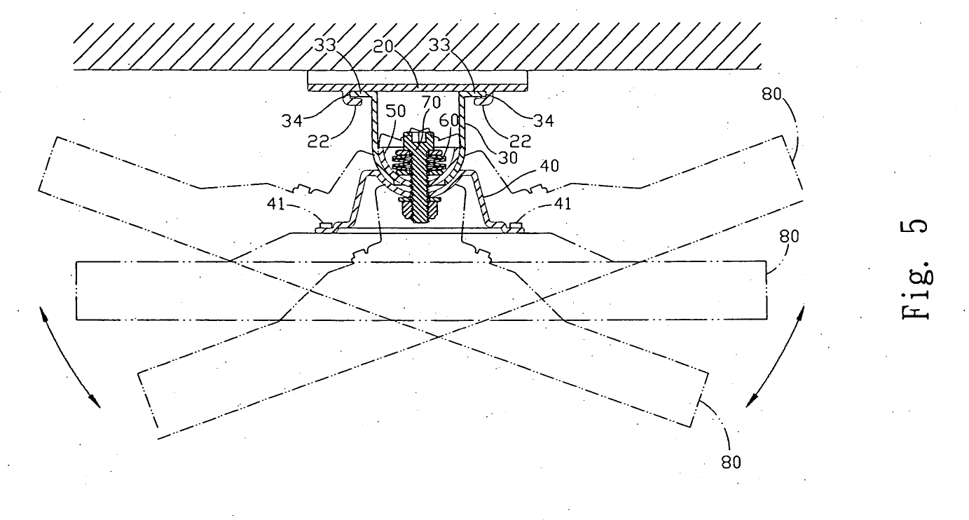

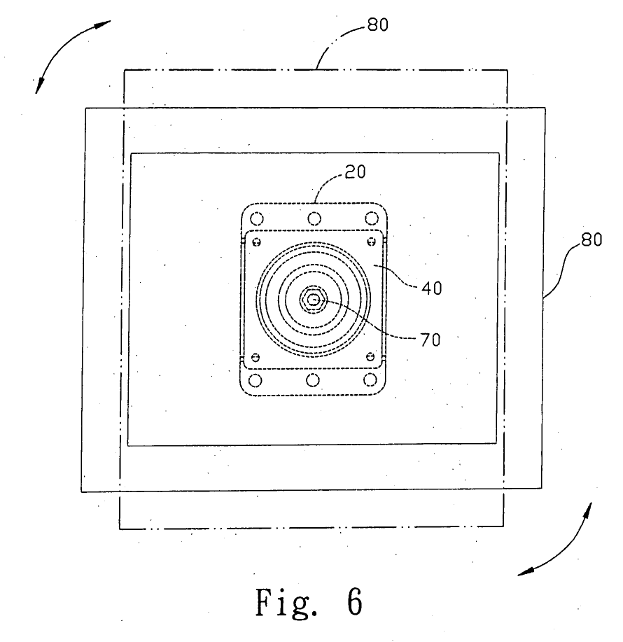

In assembly, the stud 70 passes through the round holes 61 of the elastic pads 60; the round hole 51 in the center of the clamping element 50; the round hole 32 of the adapting seat 30; and the rectangular hole 43 in the center of the rotary seat 40. Then front end of the stud 70 protruded from the rotary seat 40 is locked with a nut 72. Thereby, the adapting seat 30, rotary seat 40, clamping element 50 and plurality of elastic pads 60 are combined. Furthermore, by the elastic force of the elastic pads 60, the clamping element 50 and the rotary seat 40 can be tightly clamped at two sides of the dome-like surface 31 of the adapting seat 30. Thus, the rotary seat 40 can be supported and fixed to the liquid crystal display 80. When the orientation of the liquid crystal display 80 is adjusted, it is only to move the liquid crystal display 80, the rotary seat 40 and the clamping element 50 fixed to the backside of the liquid crystal display 80 are adjusted so as to adjust the elevation angle thereof, see FIG. 4, or to adjust horizontal angle, see FIG. 5 or to rotate through a whole cycle, see FIG. 6. Thereby, the liquid crystal display 80 can be adjusted through a wide range. Furthermore, by the retaining seat 20 to fix to a wall or other object, the liquid crystal display 80 has wide applications.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A universal adaptor used in a display comprising:
a retaining seat capable of being fixed to an object by a stud;
an adapting seat having an inward protruded dome-like surface;
a rotary seat locked to a backside of a liquid crystal display; the rotary seat having a forward protruded dome-like surface matched to the dome-like surface of the adapting seat;
a clamping element having a dome-like shape matched to the dome-like surface of the adapting seat;
a plurality of elastic pads; each elastic pad having a round pad; a center of each elastic pad having a round hole; a plurality of elastic pads being linearly arranged so as to combined as a strong elastic element;
a stud having a rectangular end portion;
wherein in assembly, the stud passes through the round holes of the elastic pads; a round hole in the center of the clamping element; a round hole in the adapting seat; and a rectangular hole in the center of the rotary seat; a front end of the stud protruded from the rotary seat is locked with a nut; thereby, the adapting seat, the rotary seat, the clamping element and the plurality of elastic pads are combined; furthermore, by the elastic force of the elastic pads, the clamping element and the rotary seat are tightly clamped at two sides of the dome-like surface of the adapting seat; thus, the rotary seat is supported and fixed to the liquid crystal display; the rotary seat and the clamping element fixed to the backside of the liquid crystal display are adjusted so as to adjust the elevation angle thereof, or to adjust horizontal angle thereof, or to rotate through a whole cycle.

2. The universal adaptor used in a display as claimed in claim 1, wherein a front surface of the retaining seat has two ears; each ear is inclined inwards and downwards; a gap between upper ends of the two each ears is larger than a gap between lower ends of the two ears; a periphery of the adapting seat is a lip; two sides of the lip are formed with respective inclined surfaces so that the adapting seat is fixed to the retaining seat by placing the inclined surfaces of the lip between the two ears; thereby, the adapting seat is combined to the retaining seat.
